(19) United States
(12) Patent Application Publication
(10) Pub. No.: US 2011/0243804 A1
(43) Pub. Date: Oct. 6, 2011

(54) METHOD AND SYSTEM FOR SUPERHEATING STEAM

(76) Inventor: Benjamin Campbell Steinhaus, Houston, TX (US)

(21) Appl. No.: 12/754,391

(22) Filed: Apr. 5, 2010

(51) Int. Cl. B01J 19/00; F28F 1/00

(52) U.S. Cl. 422/198; 165/177

(57) ABSTRACT

A method and system for recovering heat in a gasifier are provided. The gasifier includes a pressure vessel including a substantially cylindrical shell, an upper head, and a lower head. The gasifier also includes a refractory wall substantially concentric with the shell and spaced apart radially inwardly from the shell, and a superheater heat exchanger mounted between the shell and the refractory wall.

### BACKGROUND OF THE INVENTION

The field of the invention relates generally to gasification systems, and more specifically, to a method and a system for superheating steam generated in a radiant synthetic gas (syngas) cooler (RSC).

In quench gasifiers a carbonaceous fuel is partially oxidized in a combustion zone to form a gaseous byproduct and typically an ash or other waste product. The partial oxidation process releases large quantities of heat, which is useful for conversion to mechanical energy in, for example, a turbine engine. The heat also tends to reduce the life of components in the gasification system. One component affected by the excess heat is a refractory wall surrounding the combustion zone.

Radiant syngas coolers are used to remove heat from the gaseous byproducts that exit the combustion zone. RSCs can be coupled in flow communication with the gasifier using piping and/or flanges or may be formed integrally with the gasifier and housed in a single vessel with the gasifier. RSCs include a plurality of heat exchanger pendants arranged to remove heat from the gaseous byproducts flowing through the RSC. The steam/water mixture formed in the heat exchangers is channeled to a steam drum where saturated steam is withdrawn and channeled to downstream processes to do work or heat other fluids. However, superheating the saturated steam would increase the quality and usefulness of the steam.

### BRIEF DESCRIPTION OF THE INVENTION

In one embodiment, a gasifier includes a pressure vessel including a substantially cylindrical shell, an upper head, and a lower head. The gasifier also includes a refractory wall substantially concentric with the shell and spaced apart radially inwardly from the shell, and a superheater heat exchanger mounted between the shell and the refractory wall.

In another embodiment, a method of heat recovery in a gasifier is provided. The gasifier includes a combustion zone surrounded by a wall of refractory, a shell of a pressure vessel surrounding the wall of refractory, and a heat exchanger. The method includes providing the heat exchanger in an annular space between the wall of refractory and shell and receiving a flow of saturated steam at an inlet of the heat exchanger. The method also includes receiving a flow of heat from the combustion zone, by the saturated steam such that the steam is superheated and transmitting the heat from the heat exchanger using the superheated steam.

In yet another embodiment, a gasification system includes a gasifier having a substantially cylindrical shell, an upper head, and a lower head. The gasification system also includes a combustor within the gasifier wherein the combustor is configured to direct products of combustion to an outlet passage of the gasifier and a fuel injection system configured to inject a fuel into the combustor. The gasification system further includes a refractory wall substantially concentric with the shell and spaced apart radially inwardly from the shell and a superheater heat exchanger between the shell and the refractory wall.

### BRIEF DESCRIPTION OF THE DRAWINGS

FIGS. 1-3 show exemplary embodiments of the method and system described herein.

FIG. 1 is a schematic diagram of an integrated gasification combined-cycle (IGCC) power generation system in accordance with an exemplary embodiment of the present invention;

FIG. 2 is a side elevation view of the gasifier shown in FIG. 1 in accordance with an exemplary embodiment of the present invention; and

FIG. 3 is a perspective view of the annular superheater heat exchanger shown in FIG. 2 in accordance with an exemplary embodiment of the present invention.

### DETAILED DESCRIPTION OF THE INVENTION

The following detailed description illustrates embodiments of the invention by way of example and not by way of limitation. It is contemplated that the invention has general application to removing heat from an area of excess and using the heat in a recoverable manner to improve the efficiency of systems in industrial, commercial, and residential applications.

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

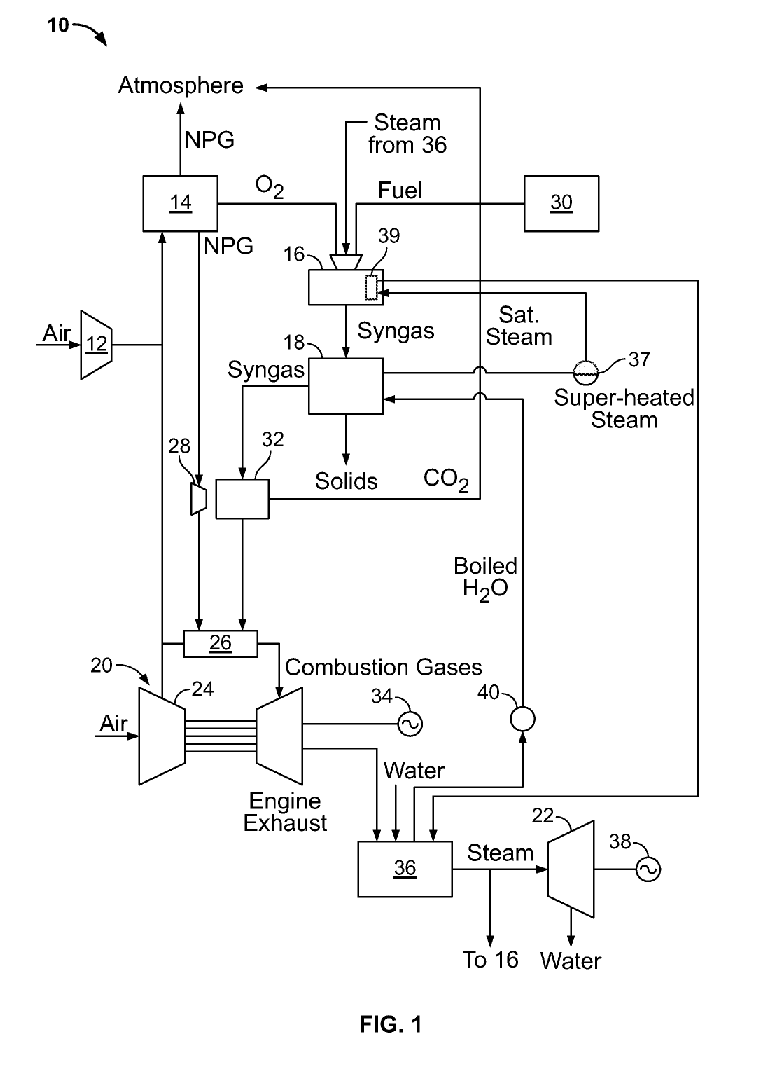

FIG. 1 is a schematic diagram of an exemplary integrated gasification combined-cycle (IGCC) power generation system 10. IGCC system 10 generally includes a main air compressor 12, an air separation unit (ASU) 14 coupled in flow communication to compressor 12, a gasifier 16 coupled in flow communication to ASU 14, a radiant syngas cooler (RSC) 18 coupled in flow communication to gasifier 16, a gas turbine engine 20 coupled in flow communication to syngas cooler 18, and a steam turbine 22 coupled in flow communication to syngas cooler 18. In various embodiments, gasifier 16 and RSC 18 are separate pressure vessels coupled in flow communication using interconnecting piping or flange-to flange mating. In other embodiments, gasifier 16 and RSC 18 are formed of a single pressure vessel having a gasifier portion and an RSC portion. In one embodiment, the RSC portion is positioned radially outwardly from the gasifier portion together in a single pressure vessel.

In operation, compressor 12 compresses ambient air that is then channeled to ASU 14. In the exemplary embodiment, in addition to compressed air from compressor 12, compressed air from a gas turbine engine compressor 24 is supplied to ASU 14. Alternatively, compressed air from gas turbine engine compressor 24 is supplied to ASU 14, rather than compressed air from compressor 12 being supplied to ASU 14. In the exemplary embodiment, ASU 14 uses the compressed air to generate oxygen for use by gasifier 16. More specifically, ASU 14 separates the compressed air into separate flows of oxygen (O2) and a gas by-product, sometimes referred to as a “process gas.” The O₂ flow is channeled to gasifier 16 for use in generating partially oxidized gases, referred to herein as “syngas” for use by gas turbine engine 20 as fuel, as described below in more detail.

The process gas generated by ASU 14 includes nitrogen and will be referred to herein as “nitrogen process gas” (NPG). The NPG may also include other gases such as, but not limited to, oxygen and/or argon. For example, in the exemplary embodiment, the NPG includes between about 95% and about 100% nitrogen. In the exemplary embodiment, at least some of the NPG flow is vented to the atmosphere from ASU 14, and at some of the NPG flow is injected into a combustion zone (not shown) within a gas turbine engine combustor 26 to facilitate controlling emissions of engine 20, and more specifically to facilitate reducing the combustion temperature and reducing nitrous oxide emissions from engine 20. In the exemplary embodiment, IGCC system 10 includes a compressor 28 for compressing the nitrogen process gas flow before being injected into the combustion zone of gas turbine engine combustor 26.

In the exemplary embodiment, gasifier 16 converts a mixture of fuel supplied from a fuel supply 30, O₂ supplied by ASU 14, steam, and/or limestone into an output of syngas for use by gas turbine engine 20 as fuel. Although gasifier 16 may use any fuel, gasifier 16, in the exemplary embodiment, uses coal, petroleum coke, residual oil, oil emulsions, tar sands, and/or other similar fuels. Furthermore, in the exemplary embodiment, the syngas generated by gasifier 16 includes carbon dioxide.

In the exemplary embodiment, syngas generated by gasifier 16 is channeled to syngas cooler 18 to facilitate cooling the syngas, as described in more detail below. The cooled syngas is channeled from cooler 18 to a clean-up device 32 for cleaning the syngas before it is channeled to gas turbine engine combustor 26 for combustion thereof. Carbon dioxide (CO₂) may be separated from the syngas during clean-up and, in the exemplary embodiment, may be vented to the atmosphere. Gas turbine engine 20 drives a generator 34 that supplies electrical power to a power grid (not shown). Exhaust gases from gas turbine engine 20 are channeled to a heat recovery steam generator (HRSG) 36 that generates steam for driving steam turbine 22. Power generated by steam turbine 22 drives an electrical generator 38 that provides electrical power to the power grid. In the exemplary embodiment, steam from HRSG 36 is supplied to gasifier 16 for generating syngas.

Furthermore, in the exemplary embodiment, system 10 includes a pump 40 that supplies boiled water from HRSG 36 to syngas cooler 18 to facilitate cooling the syngas channeled from gasifier 16. The boiled water is channeled through syngas cooler 18 wherein the water is converted to steam. The boiled water generally comprises a steam/water mixture that is separated into a flow of high-pressure steam and water in a steam drum 37. The steam from steam drum 37 is channeled to a superheater 39 positioned within gasifier 16 and is then channeled to HRSG 36.

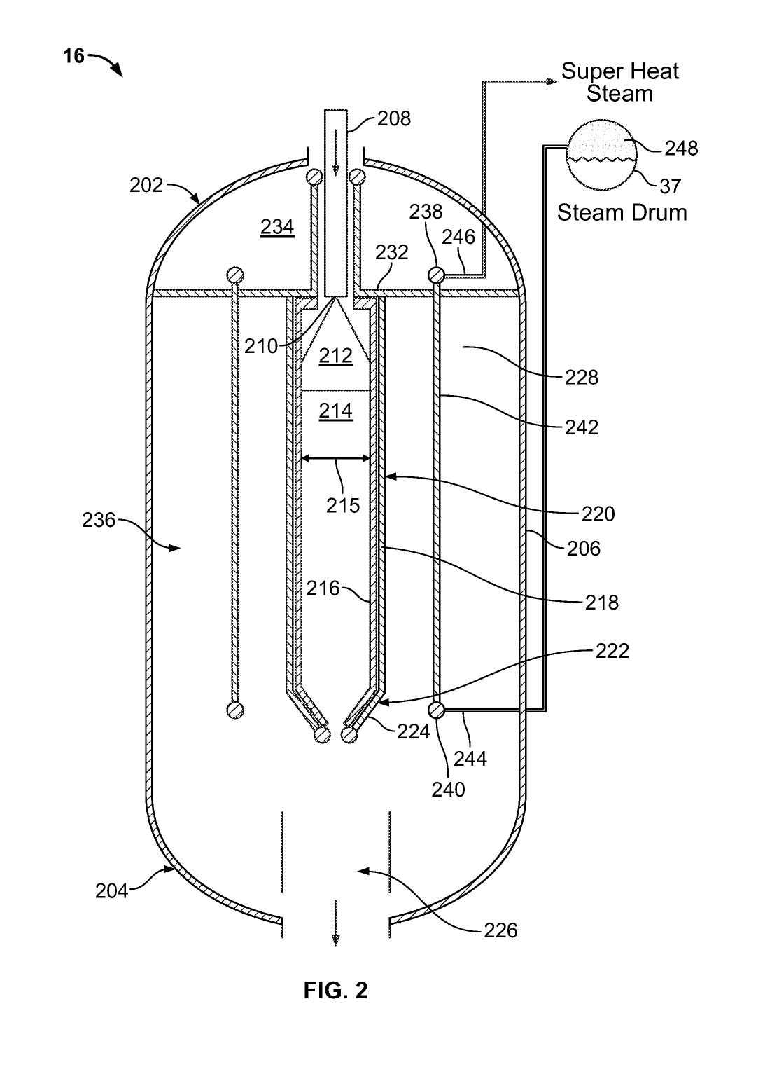

FIG. 2 is a side elevation view of gasifier 16 (shown in FIG. 1) in accordance with an exemplary embodiment of the present invention. In the exemplary embodiment, gasifier 16 includes an upper head 202, a lower head 204, and a substantially cylindrical pressure vessel body or shell 206 extending therebetween. A feed injector 208 penetrates upper head 202 or vessel body 206 to enable a flow of fuel to be discharged into gasifier 16. The fuel is channeled through one or more passages defined in feed injector 208 and is discharged from a nozzle 210 in a predetermined spray pattern 212 into a combustion zone 214 defined in gasifier 16. The fuel may be mixed with other substances, for example, oxidant, and/or waste prior to entering nozzle 210, and/or may be mixed with the other substances while being discharged from nozzle 210.

In the exemplary embodiment, combustion zone 214 is a vertically-oriented, substantially cylindrical, space that is substantially co-aligned and in serial flow communication with nozzle 210. An outer periphery 215 of combustion zone 214 is defined by a refractory wall 216 that includes a structural substrate, such as an Incoloy® pipe 218 and a refractory coating 220 that includes properties that resist the effects of the relatively high temperatures and high pressures contained within combustion zone 214. An outlet end 222 of refractory wall 216 includes a convergent nozzle 224 that is oriented and designed to facilitate maintaining a predetermined back pressure in combustion zone 214, while permitting products of partial oxidation and syngas generated in combustion zone 214 to exit combustion zone 214. The products of combustion include gaseous byproducts, a slag formed generally on refractory coating 220 and fine particulates carried in suspension with the gaseous byproducts.

In one embodiment, after exiting combustion zone 214, the flowable slag and solid slag are gravity fed into a solids quench pool 226 contained in lower head 204. Solids quench pool 226 is maintained with a level of water that quenches the flowable slag into a brittle solid material that may be broken in smaller pieces after being removed from gasifier 16. Solids quench pool 226 also traps approximately ninety percent of fine particulate exiting combustion zone 214. In various other embodiments, after exiting combustion zone 214, the products of partial oxidation, the flowable slag and solid slag are gravity fed into a radiant syngas cooler (RSC) in a separate vessel from gasifier 16.

In the exemplary embodiment, an annular superheater heat exchanger 228 at least partially surrounds combustion zone 214 radially outwardly from refractory wall 216 and radially inwardly from shell 206. A top flange 232 separates a volume 234 under upper head 202 from a volume 236 surrounded by shell 206. In the exemplary embodiment, heat exchanger 228 includes an upper ring header 238, a lower ring header 240, and a plurality of heat exchanger tubes 242 extending therebetween. In one embodiment, heat exchanger tubes 242 are membrane tubes that include a membrane or web between adjacent tubes that prevents flow around the outside of the tubes between adjacent tubes. In another embodiment, the plurality of heat exchanger tubes 242 are all in parallel with each other with respect to flow through the tubes. In various embodiments, some tubes may be arranged in series flow between upper ring header 238 and lower ring header 240. Heat exchanger 228 includes an inlet 244 and an outlet 246. Inlet 244 is coupled in flow communication to a steam portion 248 of steam drum 37. Heat exchanger 228 is configured to receive a flow of saturated steam from steam drum 37 and transfer heat energy to the received steam such that the flow of steam exiting heat exchanger 228 is superheated. The heat energy is received through refractory wall 216 from combustion zone 214. The superheated steam is directed to, for example, HRSG 36 (shown in FIG. 1).

During operation, a combustion or partial oxidation process occurring in combustion zone 214 releases large quantities of heat. Refractory wall 216 contains much of the heat for use in maintaining combustion in combustion zone 214 and for use in downstream processes. Some heat energy is transmitted by conduction through refractory wall 216. Steam in steam drum 37 is at saturation conditions. To make the steam from steam drum 37 more useful and to remove the unwanted heat from between refractory wall 216 and shell 206, heat exchanger 228 receives the heat transmitted through refractory wall 216 to superheat the steam.

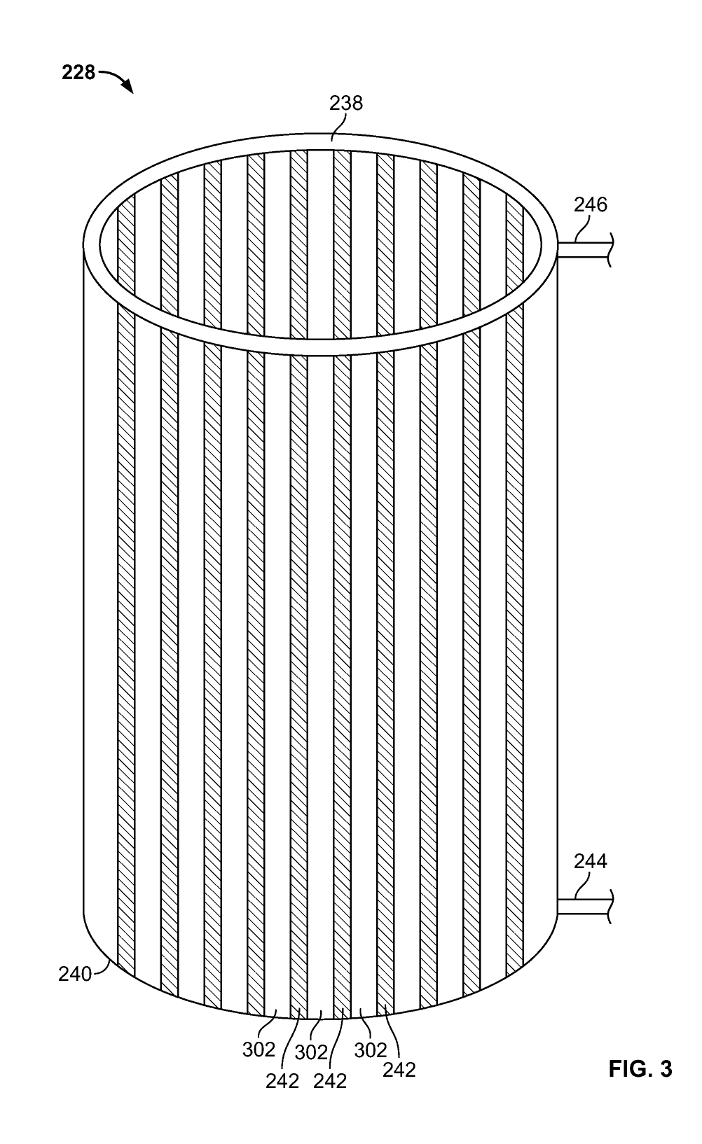

FIG. 3 is a perspective view of annular superheater heat exchanger 228 (shown in FIG. 2) in accordance with an exemplary embodiment of the present invention. In the exemplary embodiment, heat exchanger 228 includes an upper ring header 238, a lower ring header 240, and a plurality of heat exchanger tubes 242 extending therebetween. In one embodiment, heat exchanger tubes 242 are membrane tubes that include a web or membrane 302 between adjacent tubes that prevents flow around the outside of the tubes between the adjacent tubes.

Heat exchanger 228 includes an inlet 244 and an outlet 246. Inlet 244 is couplable in flow communication with a source (not shown) of for example, saturated steam. Heat exchanger 228 is configured to receive a flow of saturated steam from the source and transfer heat energy to the received steam such that the flow of steam exiting heat exchanger 228 is superheated. The heat energy is received through refractory wall 216 from combustion zone 214. The superheated steam is directed to, for example, a heat recovery steam generator, such as HRSG 36 (shown in FIG. 1).

The above-described embodiments of a method and system of superheating steam provides a cost-effective and reliable means for recovering heat from gasifier waste heat to superheat saturated steam from a radiant syngas cooler steam drum. More specifically, the method and system described herein facilitate recovering waste heat from an annular space between the combustion zone in the gasifier and the shell of the gasifier. In addition, the above-described method and system facilitate improving the efficiency of an IGCC by improving the quality of steam from the RSC using recovered waste heat from the gasifier. As a result, the method and system described herein facilitate operating the IGCC in a cost-effective and reliable manner.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A gasifier comprising:
a pressure vessel comprising a substantially cylindrical shell, an upper head, and a lower head;
a refractory wall substantially concentric with said shell and spaced apart radially inwardly from said shell; and
a superheater heat exchanger mounted between said shell and said refractory wall.

2. A gasifier in accordance with claim 1, wherein said heat exchanger comprises an upper ring header, a lower ring header, and a plurality of heat exchanger tubes extending therebetween.

3. A gasifier in accordance with claim 2, wherein said heat exchanger comprises membrane tubes.

4. A gasifier in accordance with claim 1, wherein said heat exchanger comprises an inlet and an outlet, said inlet coupled to a steam portion of a steam drum.

5. A gasifier in accordance with claim 1, wherein said heat exchanger is configured to receive a flow of saturated steam and transfer heat energy to the received steam such that the flow of steam exiting said heat exchanger is superheated.

6. A gasifier in accordance with claim 1, wherein said heat exchanger is configured to direct a flow of superheated steam to a heat recovery steam generator.

7. A method of heat recovery in a gasifier having a combustion zone surrounded by a wall of refractory, a shell of a pressure vessel surrounding the wall of refractory, and a heat exchanger, said method comprising:
providing the heat exchanger in an annular space between the wall of refractory and shell;
receiving a flow of saturated steam at an inlet of the heat exchanger;
receiving a flow of heat from the combustion zone, by the saturated steam such that the steam is superheated; and
transmitting the heat from the heat exchanger using the superheated steam.

8. A method in accordance with claim 7, wherein providing the heat exchanger in an annular space comprises providing a membrane tube heat exchanger in the annular space.

9. A method in accordance with claim 7, wherein providing the heat exchanger in an annular space comprises providing a membrane tube heat exchanger comprising at least one of an upper ring header that at least partially circumscribes said wall of refractory and a lower ring header that at least partially circumscribes said wall of refractory.

10. A method in accordance with claim 7, wherein receiving a flow of saturated steam at an inlet of the heat exchanger comprises receiving the flow of saturated steam from a steam drum of a radiant synthetic gas cooler (RSC).

11. A method in accordance with claim 7, further comprising directing the superheated steam to a heat recovery steam generator.

12. A method in accordance with claim 7, further comprising directing the superheated steam to a turbine.

13. A gasification system comprising:
a gasifier having a substantially cylindrical shell, an upper head, and a lower head;
a combustor within said gasifier, said combustor configured to direct products of combustion to an outlet passage of said gasifier;
a fuel injection system configured to inject a fuel into said combustor;
a refractory wall substantially concentric with said shell and spaced apart radially inwardly from said shell; and
a superheater heat exchanger between said shell and said refractory wall.

14. A system in accordance with claim 13, wherein said heat exchanger comprises an upper ring header, a lower ring header, and a plurality of heat exchanger tubes extending therebetween.

15. A system in accordance with claim 14, wherein said heat exchanger comprises membrane tubes.

16. A system in accordance with claim 13, wherein said heat exchanger comprises an inlet and an outlet, said inlet coupled in flow communication to a radiant syngas cooler (RSC).

17. A system in accordance with claim 13, wherein said heat exchanger comprises an inlet and an outlet, said inlet coupled in flow communication to a steam portion of a steam drum.

18. A system in accordance with claim 13, wherein said heat exchanger is configured to receive a flow of saturated steam and transfer heat energy to the received steam such that the flow of steam exiting said heat exchanger is superheated.

19. A system in accordance with claim 13, wherein said heat exchanger is configured to direct a flow of superheated steam to a heat recovery steam generator.

20. A system in accordance with claim 13, wherein said heat exchanger is configured to direct a flow of superheated steam to a turbine.
